(19) United States
(12) Patent Application Publication
(10) Pub. No.: US 2005/0222281 A1
(43) Pub. Date: Oct. 6, 2005

(54) Solid blowing agent preparations and process for their preparation

(75) Inventor: Peter-Roger Nyssen, Dormagen (DE)

Correspondence Address: William C. Gerstenzang;Norris, McLaughlin & Marcus P.A., 18th Floor, 875 Third Avenue, New York, NY, 10022, US

(73) Assignee: Lanxess Deutschland GmbH, Leverkusen (DE)

(21) Appl. No.: 11/083,403

(22) Filed: Mar. 18, 2005

(30) Foreign Application Priority Data
Mar. 20, 2004 (DE) 1020040137978

(51) Int. Cl. C08J 9/22

(52) U.S. Cl. 521/57

(57) ABSTRACT

The present invention relates to novel blowing agent preparations, to a process for their preparation, and to their use. The present invention also relates to a process for the preparation of azodicarbonamide.

The present invention relates to novel blowing agent preparations, to a process for their preparation, and to their use. The present invention also relates to a process for the preparation of azodicarbonamide.

### BACKGROUND OF THE INVENTION

One of the industrial uses of blowing agents is for the foaming of PVC, rubber, polyolefins, such as polyethylene or polypropylene, or else other thermoplastic polymers. The chemical synthesis of azodicarbonamide, which is one of the most important blowing agents, is well-known and can be found by way of example in DE 69 116 867 A1 (U.S. Pat No. 5,241,117). The form in which these blowing agents are used nowadays is that of their fine-particle powders, and to a much lesser extent also that of blowing agent preparations, which are mixtures with activators and/or with other blowing agents, or else polymer-specific masterbatches. Depending on the desired application, the blowing agent powders have different particle fineness levels, and these are produced by air-jet processes known per se, e.g. comminution in spiral jet mills, following chemical synthesis and drying. The powders thus prepared have average primary particle sizes (based on weight) of from 2 to 100 μm, and broad particle size distributions, and therefore cause high levels of dust contamination during the preparation process and in applications. Dusts of blowing agent powders are moreover generally capable of causing dust explosion and/or deflagration. Another disadvantage of the known blowing agent powders is poor flow performance resulting from the morphology of the powders and broad particle size distribution with a high proportion of fine primary particles. This applies particularly to azodicarbonamide.

In order to improve dusting performance, EP 0 943 655 A1 (=U.S. Pat. No. 6,399,201) uses a method similar to that long known for dyes and pigments, applying oily substances such as natural fats and oils, long-chain hydrocarbons and fatty acids as dust binders to the powders, and incorporating these materials by mixing. However, this method can only improve dusting to some extent, and in particular a high content of dust binder is known to impair flow performance or cause caking and/or clumping of the blowing agents. This makes it more difficult to store the products.

Although polymer masterbatches, in the form of a mixture composed of blowing agent and specific polymers, generally have granular form and have better dusting performance than the pure blowing agent powders, they are unfortunately not capable of universal use, because specific polymers are used.

JP 3438043 describes granular blowing agents with low dust levels, comprising a surfactant and/or an organic or inorganic binder alongside the blowing agent. The granules are obtained via accumulative agglomeration in a mixer and/or fluidized bed, by adding binder and surfactant in the form of an aqueous formulation to the blowing agent and drying the materials. Suitable choice of the surfactant is expected to give improved dispersibility in the medium used. According to JP 3438043, the use of a binder is necessary for process-related reasons (it binds the primary particles of blowing agent within the granules) but it has to be regarded as a disadvantage when considering the redispersibility needed in applications and the versatility of the granules. Disadvantages related to the process are also likely to occur, e.g. aggregation of primary particles as a result of inhomogeneous covering with the agents mentioned, or undesired alteration of the grain size distribution of the primary particles of blowing agent due to energy input during the subsequent mixing process.

As mentioned above, blowing agents such as azodicarbonamide are milled by means of dry milling processes to give the desired fine primary particle size distribution after their synthesis and drying. Because the products can explode, it is preferable to use air-jet mills, e.g. spiral jet mills, which have disadvantages in terms of high specific energy input—equivalent to high milling costs—and in terms of broad particle size distribution in the resultant products. Average primary particle diameters below 2 μm are not achievable with air-jet mills at industrially acceptable energy cost levels. The specific energy input for comminution using air in the spiral jet mills when comminuting, by way of example, azodicarbonamide with an average initial particle size of about 25 μm to give average primary particle sizes of from 4 to 2 μm is from about 6000 to 12 000 kJ/kg of product.

An object on which the invention was based was to provide blowing agent preparations with low dust levels which are prepared without agglomeration and without the aid of a binder, which have a relatively narrow primary particle size distribution, and which are prepared in an environmentally compatible manner because the comminution process consumes very little energy. The inventive blowing agent preparations moreover preferably have wider or more universal applicability, and good flow performance, and are preferably easy to store.

This object has been achieved by means of blowing agent preparations comprising
a) at least one organic and/or one inorganic blowing agent and
b) if appropriate a surfactant compound,
   where the water content of the blowing agent preparations is less than 3% by weight, based on the blowing agent preparation, preferably less than 1% by weight, and their average particle size is from 20 to 5000 μm, preferably from 100 to 1000 μm. The expression average particle size in this context relates to particles in the form of granules or agglomerates which are generally composed of a large number of relatively small particles which may be called individual or primary particles. For the purposes of this application, average particle size is the number average determined by counting the granules under a microscope, or the median value of the distribution by weight from sieve analysis. The inventive solid blowing agent preparation is preferably based on a cylindrical or spherical particle structure, particularly preferably on a spherical to near-spherical particle structure, on agglomerates of relatively small near-spherical particles, and/or on agglomerates of primary particles.

The blowing agent preparations preferably comprise
a) from 2 to 99.99% by weight, in particular from 70 to 99% by weight, based on the entire blowing agent preparation, of at least one organic and/or inorganic blowing agent and
b) from 0 to 10% by weight, preferably from 0.01 to 5% by weight, based on the entire blowing agent preparation, of a surfactant compound and
c) if appropriate up to 98% by weight, based on the entire blowing agent preparation, of other additives,
   where the entirety of the percentages by weight of the organic and/or inorganic blowing agents, of the surfactant compound and, if appropriate, of other additives must give 100% by weight.

### DETAILED DESCRIPTION

The organic and/or inorganic blowing agents are selected from the widely known blowing agents and according to the invention are not subject to any restrictions. They are generally solid, crystalline and/or amorphous, organic or inorganic compounds, in particular compounds not soluble in water.

Preferred organic blowing agents used are azodicarbonamide (ADCA), hydrazodicarbonamide (HDCA), oxybissulphohydrazide (OBSH) (=p,p′-oxybis(benzenesulphonic hydrazide), toluenesulphohydrazide (TSH) (=p-toluenesulphonic hydrazide), dinitropentamethylenetetramine (DPT), 5-phenyltetrazole (5-PT), benzenesulphohydrazide (BSH), (=benzenesulphonyl hydrazide), paratoluenesulphonylsemicarbazide (PTSS), or their salts, in particular alkali metal salts and alkaline earth metal salts. Azodicarbonamide is preferred.

Preferred inorganic blowing agent used is sodium hydrogencarbonate or anhydrous monosodium citrate.

The organic and/or inorganic blowing agents are preferably used alone or in mixtures with one another.

The form in which the organic and/or inorganic blowing agents are used is preferably that of aqueous synthesis suspension, dry powder, water-moist filter cake, water-most suction-filter cake, and/or pressed cake. Synthesis by-products, such as salts, acid residues and/or alkaline solution residues, are preferably removed from the organic and/or inorganic blowing agents.

The organic and/or inorganic blowing agents preferably have an average primary particle size of from 0.1 to 100 μm, with preference from 0.5 to 50 μm, particularly preferably from 1 to 30 μm. For the purposes of this application, the average primary particle size is the median value from the distribution of the primary particles (individual particles) by volume, as can be determined, by way of example, by means of distribution analysis using laser light scattering or laser granulometry (laser diffraction analysis).

According to the invention, there is no restriction on the surfactant compounds to be used if appropriate, but surfactant compounds are preferably partially or fully water-soluble or -emulsifiable emulsifiers, wetting agents, dispersing agents, defoamers or solvating agents. In particular, they may be non-ionic, anionic, cationic or amphoteric and, respectively, monomeric, oligomeric or polymeric.

The surfactant compounds are preferably wetting agents and/or dispersing agents, these having solubility in water at room temperature of more than 0.01 g/l, preferably more than 0.1 g/l, and having solubility in organic media of more than 20% by weight, preferably more than 40% by weight, based on the entire solution. For the purposes of the invention, organic media are polar and non-polar solvents, hydrocarbons, oils, fats and in particular polymers.

The surfactant compounds are preferably selected from the group of the alkoxylates, alkylolamides, esters, amine oxides and/or alkylpolyglycosides.

The surfactant compounds are particularly preferably selected from the group of the reaction products of alkylene oxides with alkylatable compounds, in particular alkylene oxide adducts from the class of the reaction products of ethylene oxide and/or propylene oxide with
saturated and/or unsaturated fatty alcohols having from 6 to 25 carbon atoms;
alkylphenols having from 4 to 12 carbon atoms in the alkyl radical;
saturated and/or unsaturated fatty amines having from 14 to 20 carbon atoms;
saturated and/or unsaturated fatty acids having from 14 to 22 carbon atoms;
hydrogenated and/or non-hydrogenated resin acids;
esterification and/or arylation products prepared from naturally occurring or modified if appropriate hydrogenated castor oil fats and if appropriate linked via esterification with dicarboxylic acids to give repeat structural units.

The surfactant compounds are preferably selected from the group of the
sorbitan esters (SPAN®, ICI);
reaction products of alkylene oxide with sorbitan ester (Tween®, ICI);
block (co)polymers based on ethylene oxide and/or propylene oxide (Pluronic®, BASF);
block (co)polymers of ethylene oxide on bifunctional amines and/or of propylene oxide on bifunctional amines (Tetronic®, BASF);
(poly)stearic-acid- and (poly)alkylene-oxide (Hypermer® B, ICI) based block copolymers, alkoxylated acetylenediols and -glycols (Surfynol®, AirProducts);
polymers composed of repeat succinyl units, in particular polyaspartic acid;
ionic or nonionic polymeric surfactant compounds from the group of the homo- and copolymers, graft (co)polymers and random and linear block copolymers, e.g. polyethylene oxides, polypropylene oxides, polyoxymethylenes, polytrimethylene oxides, polyvinyl methyl ethers, polyethyleneimines, polyacrylic acids, polyarylamides, polymethacrylic acids, polymethacrylamides, poly-N,N-dimethylacrylamides, poly-N-isopropylacrylamides, poly-N-acrylolglycinamides, poly-N-methacrylolglycinamides, polyvinyloxazolidones, polyvinylmethyloxazolidones;
anionic surfactant compounds, e.g. alkyl sulphates, ether sulphates, ether carboxylates, phosphate esters, sulphosuccinates, paraffinsulphonates, olefinsulphonates, sarcosinates, isothionates and taurates; or
amphoteric surfactants such as betaines and ampholytes, in particular glycinates, propionates and imidazolines.

The surfactant compound preferably comprises an ionically modified phenol/styrene polyglycol ether. Examples of ionic modification are sulphation, carboxylation or phosphation. Ionically modified compounds preferably take the form of a salt, in particular an alkali metal salt or an amine salt, preferably a diethylamine salt. It is preferable to select surfactant compounds from the group of the alkoxylated phenols having the formula I) or II) 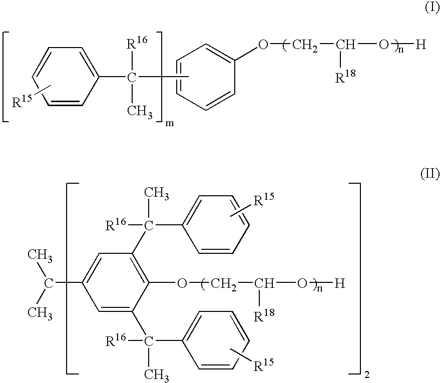
where
R¹⁵ is H or C₁-C₄-alkyl,
R¹⁶ is H or CH₃,
R¹⁷ is H, C₁-C₄-alkyl, C₁-C₄-alkoxy, C₁-C₄-alkoxycarbonyl orphenyl,
m is a number from 1 to 4,
n is a number from 2 to 50, preferably from 2 to 16,
R¹⁸ is identical or different for each unit indicated by n and represents hydrogen, CH₃ or phenyl, and, where CH₃ is present in the various —(—CH₂—CH(R¹⁸)O—)— groups, R¹⁸ represents CH₃ in from 0 to 60% of the total value of n and R¹⁸ represents hydrogen in from 100 to 40% of the total value of n, and, where phenyl is present in the various —(—CH₂—CH(R¹⁸)—O—)— groups, R¹⁸ represents phenyl in from 0 to 40% of the total value of n and R¹⁸ represents hydrogen in from 100 to 60% of the total value of n,
   these having been ionically modified, if appropriate.

The surfactant compounds are preferably selected from the group consisting of the dispersing agents, in particular of the condensates obtainable via reaction of naphthols with alkanols, addition reaction with alkylene oxide and at least partial conversion of the terminal hydroxy groups into sulpho groups or half-esters of maleic acid, phthalic acid or succinic acid, of the alkylarylsulphonates, such as alkylbenzene- or alkynaphthalenesulphonates, or of the salts of polyacrylic acids, polyethylenesulphonic acids, polystyrenesulphonic acid, polymethacrylic acids, polyphosphoric acids.

Particular preference is given to alkylbenzenesulphonates of the formula III 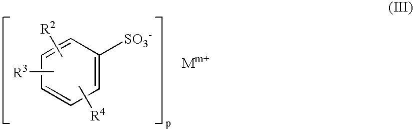
where
R², R³ and R⁴ are H or a C₁-C₂₄-alkyl radical,
   where at least one of the substituents R², R³ and R⁴ is not hydrogen,
p is 1 or 2,
M is H, an ammonium radical or an alkali metal if m=1, and is an alkaline earth metal if m=2 and
R², R³ and R⁴ are H or a C₆-C₁₈-alkyl radical.

The surfactant compounds may preferably be selected from the group of the mono- and diesters of sulphosuccinic acid and their salts, in particular those of the formula IV 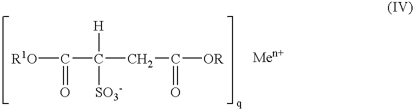
where
R and R¹ are H or a C₁-C₂₄-hydrocarbon radical, preferably a C₆-C₁₈-alkyl radical or an aralkyl radical, but where R and R¹ are not simultaneously H,
q is 1 or 2 and
Me is H, an anunonium radical or an alkali metal if n=1, and an alkaline earth metal if n=2.

Particularly preferred surfactant compounds are block (co)polymers based on ethylene oxide and/or propylene oxide, if appropriate ionically modified phenol/styrene polyglycol ethers of the formulae I) and II), alkylbenzenesulphonates of the formula III) and diesters of sulphosuccinic acid and their salts of formula IV). Very particular preference is given to sodium bistridecyl sulphosuccinate, sodium dioctyl sulphosuccinate, sodium dihexyl sulphosuccinate, sodium diamylsulphosuccinate and mixtures thereof.

According to the invention, preferred use may also be made of mixtures of the surfactant compounds.

Preferred blowing agent preparations comprise azodicarbonamide as organic and/or inorganic blowing agent and, if appropriate, a surfactant compound composed of sodium bistridecyl sulphosuccinate, sodium dioctyl sulphosuccinate and/or sodium dihexyl sulphosuccinate, sodium diamyl sulphosuccinate. These blowing agent preparations may also comprise, as additive, water-absorbents, such as silica gel, zeolites, aluminium oxide, magnesium oxide, magnesium hydroxide, calcium oxide, calcium hydroxide, organic anhydrides, and/or anhydrous inorganic salts, in particular magnesium sulphate and/or sodium carbonate.

Other preferred blowing agent preparations comprise azodicarbonamide as organic and/or inorganic blowing agent and, if appropriate, as surfactant compound, block (co)polymers based on ethylene oxide and/or on propylene oxide.

Other blowing agent preparations preferably comprise azodicarbonamide as organic and/or, if appropriate, inorganic blowing agent and, as surfactant compound, an alkylbenzenesulphonate of the formula III.

The blowing agent preparations preferably comprise other additives. Other additives preferably used are stabilizers, colorants, e.g. disperse dyes, pigments and/or fillers, foam inhibitors, coupling agents, water-absorbents, and/or organic solvents or a mixture thereof.

Preferred stabilizers used are tribasic lead sulphate, dibasic phosphites, lead stearate, zinc stearate, zinc carbonate, zinc oxide, barium stearate, aluminium stearate, calcium stearate, dibutyltin maleate, and/or urea. PVC stabilizers are particularly preferred.

Colorants used are preferably compounds from organic chemistry whose melting point is >40° C. and whose solubility in water at 20° C. is <10 g/l, in particular <1 g/l. Preferred materials which may be mentioned are disperse dyes or solvent dyes, e.g. those described in Colour Index, 3rd edition (3rd revision 1987) under “Disperse Dyes” or in Colour Index, 3rd edition (1982, Pigments and Solvent Dyes).

Disperse dyes preferably used are carboxylic-acid-group-free and/or sulphonic-acid-group-free nitro, amino, aminoketone, ketone inime, methine, polymethine, diphenylamine, quinoline, benzimidazole, xanthene, oxazine, coumarin, and preferably anthraquinone and azo dyes, such as mono- and disazo dyes. Particular preference is given to the disperse dyes which can be found in the formulae 1)-23) in EP 924335 A1 (=U.S. Pat. No. 6,284,004).

Pigments and/or fillers which may be used with preference are any of those known from the prior art, e.g. those found in: Lückert, Pigment+Füllstoff Tabellen [Pigment+filler tables], 5th edition, Laatzen, 1994. In particular, these are substances insoluble in aqueous media.

Pigments and/or fillers used with preference are inorganic white pigments, such as titanium dioxide, zinc oxide (such as ZnO, zinc white), zirconium oxide, carbonates, sulphates, sulphides and lithopones, in particular titanium dioxide.

Other pigments and/or fillers used with preference are inorganic non-neutral pigments from the group of the oxides and hydroxides in the form of their inorganic single compounds or mixed phases, in particular iron oxide pigments, chromium oxide pigments and oxidic mixed-phase pigments with rutile structure or with spinell structure, bismuth vanadate pigments, cadmium pigments, cerium sulphide pigments, chromate pigments, ultramarine pigments and iron blue pigments.

Pigments and/or fillers used with preference are iron oxide pigments, such as Colour Index Pigment Yellow 42, Pigment Red 101, Pigment Blue 11, Pigment Brown 6, and transparent iron oxide pigments. Preferred chromium oxide pigments from the Colour Index are Pigment Green 17 and Pigment Green 18. Preferred examples of oxidic mixed-phase pigments are nickel titanium yellow and chrome titanium yellow, cobalt green and cobalt blue, zinc iron brown and chrome iron brown, and iron manganese black and spinnel black. Preference is also given to iron oxide pigments, and among these red iron oxide pigments are particularly preferred.

Pigments and/or fillers which may be used with preference are organic pigments, such as those of the monoazo, disazo, laked azo, β-naphthol, naphthol AS, benzimidazolone, disazo condensation, azo metal complex, isoindoline and isoindolinone series, or else polycyclic pigments, e.g. from the phthalocyanine, quinacridone, perylene, perinone, thioindigo, anthraquinone, dioxazine, quinophthalone and diketopyrrolopyrrole series. Other materials which may be used with preference are laked dyes, such as Ca, Mg and Al lakes of sulphonic-acid-group- or carboxylic-acid-group-containing dyes, and also carbon blacks, which for the purposes of this application are pigments, and of which a large number are known, for example from Colour Index, 2nd edition [publisher, year]. Preference is given to acidic to alkaline carbon blacks prepared by the fumace-black process, and chemically modified or surface-modified blacks, such as sulpho-group- or carboxy-group-containing carbon blacks.

Other pigments and/or fillers which may be used with preference are inorganic fillers, such as calcium carbonate, talc, mica, and/or barium sulphate. Preference is given to hydrophobicized fine-particle, amorphous fumed silicas, very fine-particle, hydrophobicized kaolin and/or fine-particle aluminium oxide.

Foam inhibitors preferably used are maleic acids.

Coupling agents used with preference are silane coupling agents, aluminium coupling agents and titanate coupling agents. Other preferred coupling agents are described in more detail in EP 943655 (=U.S. Pat. No. 6,399,201).

Water-absorbents used with preference are silica gel, zeolites, aluminium oxide, magnesium oxide, calcium oxide, organic anhydrides and/or anhydrous inorganic salts, in particular magnesium sulphate and/or sodium carbonate.

Other preferred additives are magnesium hydroxide or calcium hydroxide.

The organic solvents are preferably water-soluble or water-miscible or water-insoluble. Water-insoluble organic solvents used with preference are those whose melting point is below 90° C., and which in particular are liquid at room temperature selected from the group consisting of the aliphatic, cycloaliphatic or aromatic hydrocarbons, in particular mineral oils, paraffins, isoparaffins, entirely synthetic oils, semisynthetic oils, medium-chain-length and unsaturated fatty acids, etherial oils, purified natural oils and fats, esters of natural or synthetic, saturated or unsaturated fatty acids, C₈-C₂₂ fatty acids, alkylated aromatics and their mixtures (e.g. Solvesso®), alkylated alcohols and/or linear, primary alcohols obtained via hydroformylation (e.g. Dobanol® grades).

The water-miscible or water-soluble organic solvents preferably have a boiling point above 150° C., in particular above 250° C. Water-soluble means that the solubility of the compounds in water at room temperature is >1 g/l, in particular >5 g/l. Water-miscible means that at a concentration of >5 g/l, in particular >10 g/l, the compounds do not separate from water at room temperature.

Preferred organic solvents are polyglycols or diols having at least one terminal group other than hydrogen, in particular compounds from the groups of the
ethylene glycol monoalkyl ethers, in particular the corresponding methyl ether (methyltetraglycol) and/or the corresponding butyl ether (butyldiglycol),
ethylene glycol dialkyl ethers, in particular tri- and tetraethylene glycol dimethyl ether,
propylene glycol dimethyl ether,
polyethylene glycol dimethyl ether,
polyethylene glycol dibutyl ether, in particular having from 2 to 5 molar units of ethylene oxide,
polyethylene glycol monoallyl ether, and the corresponding diallyl ether and the corresponding allyl methyl ether.

Particular preference is given to tetraethylene glycol dimethyl ether and polyethylene glycol dimethyl ether having from 3 to 22, preferably from 3 to 12, molar units of ethylene glycol.

The invention also provides a process for the preparation of the blowing agent preparations described above, characterized in that
1) at least one organic and/or one inorganic blowing agent is introduced into water together with, if appropriate, a surfactant compound and/or, if appropriate, additives, and is homogenized to give a suspension,
2) the suspension from step 1) is comminuted, if appropriate, in a wet process to an average primary particle size of from 0.1 to 100 μm for the blowing agent, preferably from 0.5 to 50 μm, particularly preferably from 1 to 30 μm,
3) the suspension comminuted in a wet process from step 2) is dried, and
4) the dried product from step 3) is treated, if appropriate, to give granules,
   where steps 3) and 4) may take place in reverse sequence or simultaneously, and the total content of organic and/or inorganic blowing agent, if appropriate of the surfactant compound and if appropriate of the additives is from 1 to 80% by weight, preferably from 30 to 60% by weight, based on the suspension prior to the drying in step 3).

The inorganic and/or organic blowing agents are preferably introduced in solid form in the form of finished or unfinished powders or aqueous synthesis suspension or in the form of water-moist filter cake or water-moist suction-filter cake or pressed cake together with, if appropriate, a portion of the surfactant compound and, if appropriate, other additives continuously or batchwise within an aqueous medium, comminuted by a wet process, if appropriate thickened and/or isolated (filtered) and then granulated and dried or directly dried to give granules.

It is preferable to use an aqueous medium whose pH is from 2 to 12, preferably from 2 to 10; the pH during the comminution by a wet process is preferably above the pH of the isoelectric point of the organic and/or inorganic blowing agent in water. The temperature at which continuous or batchwise comminution takes place in a wet process is generally from 0 to 95° C., preferably from 20 to 60° C.

The comminution in a wet process in step 2) preferably takes place by means of high-speed stirrers, dissolvers, Ultra-Turrax, rotor-stator mills, in-line mixers, low-speed ball-mills with agitator unit, or centrifugal mills with energy density of 0.1 to 0.5 kW/l, based on the effective grinding space, or by means of high-speed ball- or bead-mills with agitator unit with energy density of from 0.5 to 3 kW/l.

Other milling assemblies which may be used are dispersive kneader, roll mill, or high-pressure homogenizer.

In this context, comminution by a wet process is homogenization (=deagglomeration), milling for comminution to give primary particles, and kneading in aqueous suspension. This step of the process converts the generally coarse primary particles of the blowing agents from synthesis to the desired fine-particle state. The surfactant compounds required if appropriate and additives, if appropriate, may be added prior to, during or after the comminution by a wet process. The selection of the wet processes for comminution to achieve the desired fine particles prior to drying depends on the state of aggregation or agglomeration of the organic and/or inorganic blowing agents used and on the amount of energy required for actual primary particle comminution in order to achieve the desired fine-particle state (degree of fineness). By way of example, various degrees of primary particle fineness from 30 μm to 2 μm are required for azodicarbonamide, depending on the application sector. If the size distribution of the primary particles of the organic and/or inorganic blowing agents is as desired prior to input, homogenization is generally sufficient, possible methods therefore being high-speed stirrer, dissolver, Ultra-Turrax or rotor-stator mills, or else in-line mixers. However, if primary particle comminution (genuine comminution) is required for the desired fine size distribution, in particular for high degrees of fineness (<=15 em), there may be an additional requirement for wet-milling techniques with high to very high energy input. By way of example, this energy is provided either via low-speed ball-mills with agitator unit or centrifugal mills with energy density of from 0.1 to 0.5 kW/l, based on the effective grinding space, or via high-speed ball- or bead-mills with agitator unit with energy density of from 0.5 to 3 kW/l.

It is preferable to use mills known as centrifugal mills, e.g. centrifugal tube mills (see, for example, Kurrer et al., Clausthal Technical University, “Zentrifugalrohrmühle zur Feinstzerkleinerung” [Centrifugal tube mill for very fine comminution], Chemie Technik, Volume 32, March 2003) and what are known as high-performance bead-mills with agitator unit of vertical or horizontal design, e.g. of Advantis® type, or from Drais/Bühler AG. Grinding beads used comprise metal beads, glass beads or ceramic beads, preferably ceramic beads whose diameter is from 0.1 to 5 mm, in particular from 0.4 to 2 mm.

The comminution by a wet process in step 2) preferably takes place either batchwise or continuously in a single-pass or circulating procedure by way of one or more milling assemblies with, if appropriate, different milling components.

### BRIEF DESCRIPTION OF THE DRAWINGS

FIG. 1 Depicts a circulating procedure for milling.

FIG. 2 Depicts a single-pass procedure for milling.

FIG. 3 Is a photomicrograph of the blowing agent preparation of the invention (Example 3).

FIG. 4 Is a photomicrograph of a prior art blowing agent, used as a comparison in Example 3.

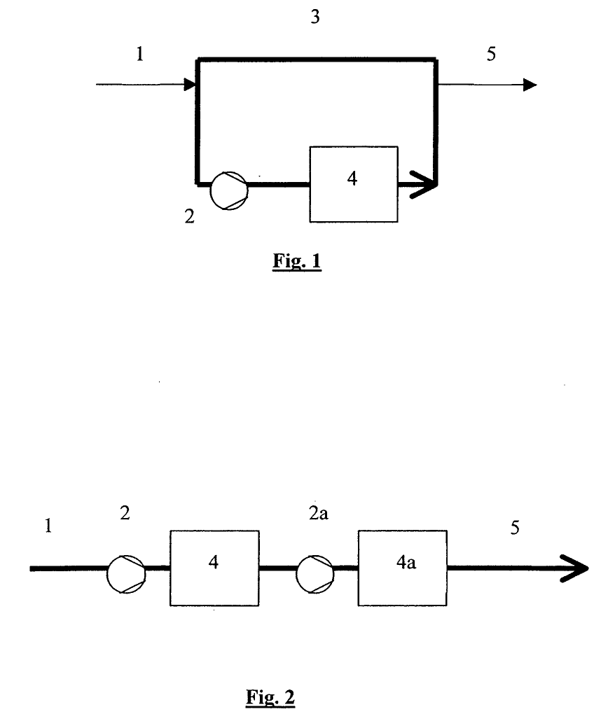

In a circulating procedure (FIG. 1) a pump 2 and at least one milling assembly 4 produce a milling circuit 3 with high flow rate, the crude blowing agent suspension 1 being fed continuously to the system and the same amount of the resultant fine-particle blowing agent suspension 5 being continuously drawn off.

In a single-pass procedure (FIG. 2), two or more milling assemblies 4, 4a have been arranged in series, and the milling suspension is fed to the milling assemblies continuously by means of pumps 2, 2a.

The resultant aqueous blowing agent suspensions are, if appropriate, then adjusted with, if appropriate, other organic and/or inorganic blowing agents and/or with other surfactant compounds and/or with further water and/or with further additives mentioned, to give a consistency and composition desirable for subsequent drying.

According to the invention, the form in which the organic and/or inorganic blowing agent is introduced to the wet-milling process may also be that of its aqueous synthesis-suspension, with resultant omission of any intermediate isolation step. After the comminution by a wet process in step 2) and prior to the drying in step 3), neutralization and/or removal of synthesis by-products and/or salts takes place, if appropriate. The preferred method for this uses known batch processes for isolation/filtration, e.g. agitated suction filtration, pressure filtration, etc. However, particular preference is given to continuous processes using membrane technology, e.g. micro- or ultrafiltration, in particular continuous crossflow microfiltration (e.g. Dynofilter® from Bokela), if appropriate in combination with diafiltration.

Following the comminution by a wet process, the aqueous suspension is preferably converted by means of drying into the inventive solid blowing agent preparation. Depending on the process, the drying in step 3) may be carried out after, or in combination with, granulation in step 4), and, if appropriate, thickening and/or isolation (filtration) of the milling suspension may be necessary prior to drying/granulation in order to remove excess water. According to the invention, there is no restriction on combination of the steps mentioned in the process, and in particular according to the invention the drying and granulation are associated portions of the process.

The drying in step 3) and, respectively, the granulation of step 4) preferably takes place via spray drying, preferably single-fluid spray drying, by means of high-pressure nozzles or swirl nozzles, or spray drying by means of atomizer discs, or freeze-drying with upstream or downstream granulation or dry work-up, accumulative granulation, e.g. by the pan or drum granulation process, if appropriate using product which has to some extent been predried and/or had some of its moisture removed, fluidized-bed drying, fluidized-bed granulation, or mixer agglomeration and mixer drying, if appropriate in combination with fluidized-bed drying. Other processes which may be used with preference are mix-agglomeration in suspension, if appropriate in association with bridging agents, e.g. organic solvents and, if appropriate, with downstream filtration and/or fluidized-bed drying, granulation by means of paste forming and downstream after-drying and comminution or pelletization, or steam-jet agglomeration. Combinations of the processes mentioned are likewise possible.

Particularly preferred processes are single-stage spray drying by means of a centrifugal or nozzle atomizer, very particularly preferably high-pressure nozzles or swirl nozzles, spray drying with integrated or downstream fluidized-bed agglomeration and/or with downstream fluidized-bed drying, accumulative granulation by the pan process, or fluidized-bed granulation and fluidized-bed drying.

According to the invention, it is possible, if appropriate, either for other additives, e.g. antidusting agents, to be added to the suspension prior to drying/granulation, or for these to be applied, using well-known processes, to the solid blowing agent preparation during or after the drying.

The process described and the resultant blowing agent preparations achieve considerable advantages over the prior art, among which are:
1) specific energy cost for the comminution of the blowing agents is lower by a factor of up to 12 when compared with that for conventional air-jet milling; by way of example, specific energy inputs of less than 1000 kJ/kg, in particular less than 500 kJ/kg, can be achieved for azodicarbonamide at average primary particle sizes of 4 μm, and less than 2000 kJ/kg, in particular less than 1000 kJ/kg, for 2 μm;
2) the average primary particle diameters achievable are markedly finer, e.g. smaller than 2 μm, in particular smaller than 1 μm, than those conventionally possible with cost-effective use of airjet milling;
3) relatively narrow primary particle size distributions can be obtained—in particular for azodicarbonamide;
4) homogeneous mixtures of different blowing agents and breadths of distribution are readily obtainable industrially in the aqueous suspensions and prior to drying/granulation (whereas physically homogeneous dry mixtures are difficult to achieve industrially and are also frequently associated with further undesired comminution of primary particles);
5) the granular structure of the inventive solid blowing agent preparations and their composition gives them substantially improved dusting performance and dust explosion performance, and a higher bulk density than known blowing agent powders. The inventive blowing agent preparations preferably have a low dust level or are actually dust-free, and in particular they have a dust filter value above 3. The inventive blowing agent preparations in the form of granules can moreover easily be given a low dust level or rendered dust-free by means of downstream dust removal, if necessary. The dust filter value is determined by a method described by way of example in “Berger-Schunn et al, Bestimmung des Staubverhaltens von Farbstoffen [Determination of the dusting performance of dyes], Textilveredelung 24 (1989), 7/8, pp. 277-280. Here, the dust arising is removed by suction by way of filters, and the amount of deposit on the filters is determined visually. A filter value of 1 means that a large amount of dust is generated, and a filter value of 5 means that there is no detectable dust deposit on the filter, and the product has a very low dust level. The prior art nowadays requires that solids preparations subjected to very thorough dust removal retain at least a filter value of 3 even after two or more weeks of storage under cold and hot conditions.
6) the granular structure of the inventive solid blowing agent preparations and their composition makes them easy to store, and in particular they have good flow performance and dusting performance, and do not cake, even after storage (RT and 40° C.) for two or more weeks.
7) the composition of the blowing agent preparations, and their uniform covering of the primary particles in the interior of the granules, gives them excellent redispersibility in organic media, in particular in polymeric matrices;
8) the blowing agent preparations can be used in any of the known applications for blowing agents, and they are particularly suitable for the foaming of PVC, of rubber, of polyolefins, such as polyethylene or polypropylene, or of other thermoplastic polymers.

Surprisingly, in association with the abovementioned invention, a novel process for the preparation of azodicarbonamide has been found, via
1) reaction of an aqueous semicarbazide solution and/or hydrazine hydrate with urea, if appropriate after ammonia removal, to give hydrazodicarbonamide and
2) oxidation of hydrazodicarbonamide with an oxidant, preferably chlorine or hydrogen peroxide, to give azodicarbonamide,
   characterized in that a surfactant compound is used prior to and/or during step 1) and/or prior to or during step 2).

It is preferable to use from 0.001 to 2% by weight, preferably from 0.01 to 0.5% by weight, of the surfactant compound, based on the hydrazodicarbonamide formed in step 1) and/or azodicarbonamide in 2). Preferred surfactants are alkylbenzenesulphonates of the formula III) and diesters of sulphosuccinic acid and their salts of formula IV), in particular sodium dioctyl sulphosuccinate.

The novel synthesis preferably encompasses more than one stage. The synthesis of azodicarbonamide is well-known and, by way of example, converts semicarbazide by way of the intermediate hydrazodicarbonamide into azodicarbonamide as described, by way of example, in EP 0 516 853 A1(=U.S. Pat. No. 5,241,117) or DE 2548 592 A1 (=U.S. Pat. No. 4,088,643). By way of example, hydrazodicarbonamide is synthesized by reacting an aqueous semicarbazide solution, e.g. obtained via reaction of hydrazine hydrate with urea, after removal of ammonia, with from 1 to 1.2 mol of urea per mole of semicarbazide used (DE 24 52 016 A1).

The reaction is preferably carried out at a pH of 7 or below, if adjusted by addition of an acid, e.g. sulphuric acid or hydrochloric acid, and at a temperature of from 90 to 105° C., but the reaction is not restricted thereto and can also be carried out at higher pH.

The synthesis of semicarbazide and subsequent reaction to give hydrazodicarbonamide is preferably carried out in one step of the process, without intermediate isolation of the semicarbazide.

Azodicarbonamide is likewise synthesized in a known manner, by way of example by oxidizing the above hydrazodicarbonamide, either in the form of the reaction mixture or in the form of isolated crystals, in an aqueous medium, using an oxidant, e.g. chlorine or hydrogen peroxide, at a temperature of from 10 to 50° C.

Considerable industrial advantages are associated with the inventive process. A reduction in the viscosity of the synthesis suspensions is obtained, in particular in the phase at the end of the reaction in both stages of the synthesis, giving an improvement in energy input, possibly associated with an improvement in reaction yield and, respectively, a shorter reaction time. The primary particle size distribution of the synthesis suspension moreover has greater morphological uniformity, and may have a coarser average primary particle size distribution, with better filtration properties and washing properties, both in any necessary intermediate isolation of hydrazodicarbonamide and in the isolation/washing of azodicarbonamide. Associated with this are other advantages, such as relatively low resistance to filtration and more effective washing of the azodicarbonamide to remove by-products, salts and acid residues.

The examples below provide further illustration of the invention, but are not intended to restrict the invention.

### EXAMPLE 1

25 parts of demineralized water were used as initial charge in a mixer tank, with stirring
0.227 part of sodium dioctyl sulphosuccinate (Aerosol® OT 75, Cytec, active ingredient content about 75% by weight) was introduced without foaming and completely dissolved, and then
25 parts of azodicarbonamide in the form of its water-moist filter cake with pH of 6.8 and with residual moisture content of 31.8% by weight were introduced without foaming and homogenized. The median value of the primary particle size distribution d₅₀ was 25.4 μm, measured in dilute suspension by means of a Cilas® 715 E090 laser granulometer (laser diffraction, Quantachrome). By way of comparison, a measurement after drying of a suspension specimen by means of scattered laser light analysis (Helos from SYMPATEC, Sensor 207, Rodos 1042 dispersion system) gave:
   d₅₀=22.5 μm, d₁₀=7.4 μm, d₉₀=41.6 μm

The resultant suspension was then wet-milled by single-pass milling in a high-speed Advantis® V15 ball-mill from Drais/Bühler with agitator unit and with 1200 ml of grinding space, 600 rpm, zirconium oxide grinding beads of diameter 1.1-1.3 mm, bead fill level 70%, product throughput 195 kg/h with a milling power rating of 1.4 kW, in a single pass with specific energy input of 26 kJ/kg, based on the milling suspension and, respectively, 76 kJ/kg based on azodicarbonamide used. Laser granulometry gave a median value d₅₀ of 13.5 μm for the primary particle size distribution.

By way of comparison, a measurement after drying of a suspension specimen by means of scattered laser light analysis gave:
d₅₀=13.2 μm, d₁₀=5.4 μm, d₉₀=31.5 μm.

The resultant blowing agent suspension with very good flowability and with a solids content of about 34% by weight was dried in a single-stage atomizing dryer (water evaporation capacity 80 kg/h) with a high-pressure swirl nozzle (Delavan, SDX F, 1.4 mm bore), without return of fines, to give granules under the following conditions:
nozzle pressure: 19 bar
nozzle throughput: 60 kg/h
air entry temperature: 130° C.
air exit temperature: 60° C.

This gave an inventive solid blowing agent preparation in the form of dust-free granules with very good flowability and with an average particle size (by counting under a microscope) of about 140 μm, with the following composition (approx.):
98.8% by weight of azodicarbonamide (blowing agent of comp. a)
1.0% by weight of sodium dioctyl sulphosuccinate (compound of comp. b)
0.2% by weight of water (residual moisture content)

This solid blowing agent preparation had a low dust level and very good storage stability and had very good suitability for the production of crosslinked and non-crosslinked PE foams and PP foams.

For downstream dust removal, a portion of the solid blowing agent preparation was mixed homogeneously on laboratory scale on a roller bed with 0.4% by weight of white oil (Primolöl® 352, Exxon-Mobil), based on the preparation. This gave an almost dust-free preparation (see table: values in brackets).

For comparison, a portion of the abovementioned azodicarbonamide filter cake was dried conventionally in a pneumatic dryer, then milled by means of a spiral jet mill (air-jet mill) with a specific energy consumption of more than 1100 kJ/kg to give the powder; the resultant primary particle size distribution was markedly broader:
d₅₀=15.2 μm, d₁₀=3.6 μm, d₉₀=34.9 μum
Foaming Performance Test:

15 parts of the solid blowing agent preparation and of the comparison were, respectively, mixed with 100 parts of LDPE (low-density polyethylene, melt index 2.0) and with 0.8 part of dicumyl peroxide, and kneaded on a laboratory roll mill with a roll temperature of about 115° C. This gave in each case sheets of thickness 5 mm, which were pressed for 5 minutes at 120 kg/cm² at a temperature of 125° C.

The specimens taken from the sheets were foamed at 220° C. in a hot-air oven. The foam specimens obtained in the two cases had fine and uniform cells, smooth surface and comparable foaming rate.

Dusting Performance Test:

The solid blowing agent preparation, the same preparation with downstream dust removal (values in brackets) and the comparison were subjected to comparative testing of their dust filter value as described above. The dust filter values immediately after preparation and also after 4 weeks of storage at room temperature and 40° C. were:

| | Blowing agent preparation | Comparison |
|---|---|---|
| Immediate | 3 (4) | 1 |
| Storage at 25° C. | 2 (4) | 1 |
| Storage at 40° C. | 2 (4) | 1 |

### EXAMPLE 2

25 parts of demineralized water were used as initial charge in a mixer tank, with stirring
0.17 part of an ethylene oxide-propylene oxide block copolymer (Pluronic® PE10500, BASF AG) was introduced and completely dissolved, and then
25 parts of azodicarbonamide in the form of its water-moist filter cake as described in Example 1 were introduced without foaming and homogenized.

The resultant suspension was wet-milled as described in Example 1, but with a mill throughput of 210 kg/h with a specific energy input of 24 kJ/kg, based on the milling suspension, or 71 kJ/kg, based on azodicarbonamide used. The median value for the particle size distribution d₅₀ measured by means of laser granulometry was 15.0 μm.

The primary particle size distribution measured by means of scattered laser light analysis after drying of a specimen was
d₅₀=14.6 μm, d₁₀=4.7 μm, d₉₀=27 μum.

The resultant blowing agent suspension, which likewise had very good flowability, was dried as described in Example 1 under the following conditions to give granules:
nozzle pressure: 21 bar
nozzle throughput: 69 kg/h
air entry temperature: 130° C.
air exit temperature: 61° C.

This gave an inventive solid blowing agent preparation in the form of granules with low dust level and very good flowability and with an average particle size (by counting under a microscope) of about 140 μm, with the following composition (approx.):
98.9% by weight of azodicarbonamide (blowing agent of comp. a)
1.0% by weight of EO/PO block copolymer (compound of comp. b)
0.1% by weight of water (residual moisture content)

This solid blowing agent preparation had very good storage stability and had very good suitability for the production of crosslinked and non-crosslinked PE foams and PP foams.

Foaming Performance Test:

When the comparative test described in Example 1 is used, the foam specimens obtained in the two cases had fine and uniform cells, smooth surface and comparable foaming rate.

For downstream dust removal, a portion of the solid blowing agent preparation was mixed homogeneously on laboratory scale on a roller bed with 0.2% by weight of white oil (Primolöl® 352, Exxon-Mobil). This gave an almost dust-free preparation (see table: values in brackets).

Dusting Performance Test:

The solid blowing agent preparation and the same preparation with downstream dust removal were subjected to comparative testing of their dust filter value as described above in Example 1. The dust filter values immediately after preparation and also after 4 weeks of storage at room temperature and 40° C. were:

| | Blowing agent preparation | Comparison from Ex. 1 |
|---|---|---|
| Immediate | 4 (5) | 1 |
| Storage at 25° C. | 3 (4) | 1 |
| Storage at 40° C. | 3 (4) | 1 |

### EXAMPLE 3

25 parts of demineralized water were used as initial charge in a mixer tank, with stirring
0.227 part of sodium dioctyl sulphosuccinate (Aerosol® OT 75, Cytec, active ingredient content about 75% by weight) was introduced without foaming and completely dissolved, and then
25 parts of azodicarbonamide according to Example 1
   were introduced and homogenized.

The resultant suspension was then milled as described in Example 1 in a single passage through a mill, but the power consumption was 1.54 kW with a throughput of 190 kg/h and a rotation rate of 800 rpm; a further
0.227 part of sodium dioctyl sulphosuccinate (Aerosol® OT 75, Cytec) and
0.017 part of white oil (Primol® 352 oil, Exxon-Mobil)
   were then introduced into the milling suspension without foaming, and the materials were again subjected to single-pass milling under the same conditions.

The total specific energy input was about 58 kJ/kg, based on azodicarbonamides used. The median value of the primary particle size distribution d₅₀ measured by means of laser granulometry was 7.0 μm.

The resultant blowing agent suspension, which likewise had very good flowability, was dried as described in Example 1 under the following conditions to give granules:
nozzle pressure: 16 bar
nozzle throughput: 56 kg/h
air entry temperature: 130° C.
air exit temperature: 60° C.

This gave an inventive solid blowing agent preparation in the form of granules with low dust level and very good flowability and with an average particle size (by counting under a microscope) of about 150 μm, with the following composition (approx.):
97.7% by weight of azodicarbonamide (blowing agent of comp. a)
2.0% by weight of sodium dioctyl sulphosuccinate (compound of comp. b)
0. 1% of white oil
0.2% by weight of water (residual moisture content)

This solid blowing agent preparation had very good storage stability and had a low dust level.

Dusting Performance Test:

The solid blowing agent preparation was subjected to a comparative dust filter value test as described in Example 1. The commercially available product Porofor® ADC-S/C2 (Bayer Chemicals AG, d50, 6.7 μm) was used as comparison. The dust filter values immediately after preparation and also after 4 weeks of storage at room temperature and 40° C. were:

| | Blowing agent preparation | Comparison |
|---|---|---|
| Immediate | 4 | 1 |
| Storage at 25° C. | 4 | 1 |
| Storage at 40° C. | 3 | 1 |

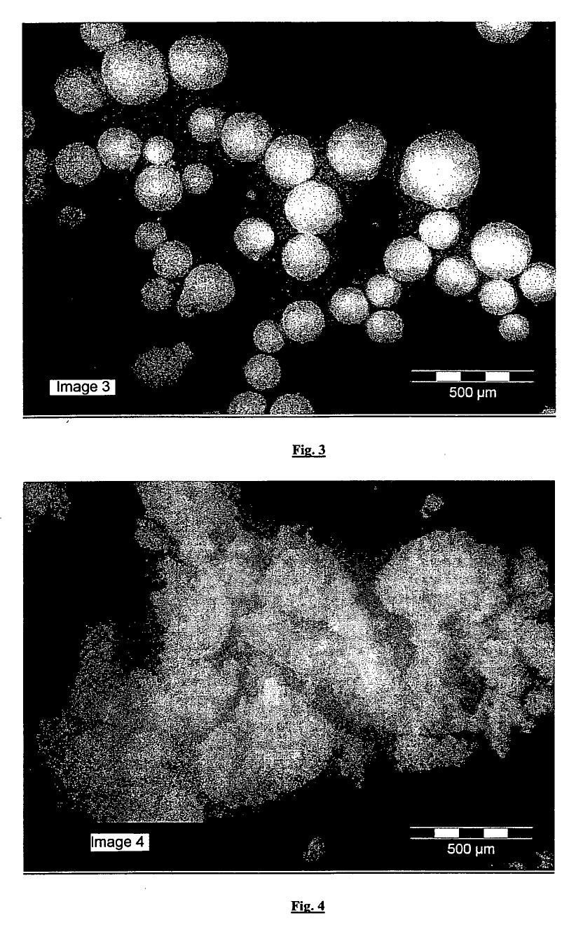

FIG. 3 and FIG. 4 show optical micrographs of the solid blowing agent preparation described in Example 3 (FIG. 3) and of the comparison (FIG. 4). The median values for the primary particles are approximately the same, as described.

### EXAMPLE 4

25 parts of demineralized water were used as initial charge in a mixer tank, with stirring
0.227 part of sodium dioctyl sulphosuccinate (Aerosol® OT 75, Cytec, active ingredient content about 75% by weight) was introduced without foaming and completely dissolved, and then
25 parts of azodicarbonamide according to Example 1
   were introduced and homogenized without foaming.

The resultant suspension was then subjected to 4 milling passes under the conditions described in Example 1, but with milling power of 1.54 kW at 800 rpm and with a throughput of 190 kg/h; a further
0.227 part of sodium dioctyl sulphosuccinate (Aerosol® OT 75, Cytec) and
0.017 part of white oil (as in Example 3)
   were then introduced into the milling suspension without foaming, and the materials were subjected to a further milling pass with milling power of 3.06 kW and a rotation rate of 1200 rpm and a throughput of 160 kg/h.

The total specific energy input was about 183 kJ/kg, based on azodicarbonamide. The median value of the particle size distribution d₅₀ measured by means of laser granulometry was 4.3 μm. The primary particle size distribution measured by means of scattered laser light analysis after drying of a suspension specimen and careful deagglomeration was
d₅₀=3.8 μm, d₁₀=1.0 μm, d₉₀=7.5 μm,
but a few agglomerates above 50 μm could still be discerned.

The resultant blowing agent suspension, which likewise had very good flowability, was dried as described in Example 1 under the following conditions to give granules:
nozzle pressure: 25 bar
nozzle throughput: 63 kg/h
air entry temperature: 130° C.
air exit temperature: 63° C.

This gave an inventive solid blowing agent preparation in the form of dust-free granules with very good flowability and with an average particle size (by counting under a microscope) of about 170 μm, with the following composition (approx.):
97.7% by weight of azodicarbonamide (blowing agent of comp. a)
2.0% by weight of sodium dioctyl sulphosuccinate (compound of comp. b)
0.1% of white oil
0.2% by weight of water (residual moisture content)

This solid blowing agent preparation had very good storage stability and excellent suitability for the foaming of PVC.

For comparison, a portion of the abovementioned azodicarbonamide filter cake was dried conventionally in a pneumatic dryer and then milled by means of a spiral jet mill with specific energy input of more than 6000 kJ/kg; the resultant primary particle size distribution was markedly broader:
d₅₀=3.93 μm, d₁₀=0.88 μm, d₉₀=8.82 μm
Dusting Performance Test:

The solid blowing agent preparation was subjected to a comparative dust filter value test as described in Example 1. The dust filter values immediately after preparation and also after 4 weeks of storage at room temperature and 40° C. were:

| | Blowing agent preparation | Comparison |
|---|---|---|
| Immediate | 4 | 1 |
| Storage at 25° C. | 4 | 1 |
| Storage at 40° C. | 3 | 1 |

### EXAMPLE 5

Using the processes described in Example 3, but without addition of a surfactant and without white oil, the result is an inventive solid blowing agent preparation in the form of granules with very good flowability but with poor dusting performance. The average primary particle size obtained was 6.9 μm.

For downstream dust removal. 0.6% by weight of polyethylene glycol dimethyl ether with average molar mass 350 g/mol were added, giving a product with equally good flowability which was almost dust-free.

| | Blowing | Blowing agent preparation |
|---|---|---|
| | agent | after downstream dust |
| | preparation | removal |
| Immediate | 3 | 5 |
| Storage at 25° C. | 2 | 4 |
| Storage at 40° C. | 2 | 4 |

1. Blowing agent preparations comprising
a) at least one organic and/or one inorganic blowing agent and
b) optionally, a surfactant compound,
wherein the water content of the blowing agent preparations is less than 3% by weight, based on the weight of the blowing agent preparation, and the blowing agent preparations are in the form of granules of primary particles, the primary particles having an average particle size of 0.1-100 μm and the granules having an average particle size of from 20 to 5000 μm.

2. The blowing agent preparation according to claim 1, wherein said water content is less than 1% by weight.

3. The blowing agent preparation according to claim 1, wherein the average particle size of said granuels is from 100 to 1000 μm

4. Blowing agent preparation according to claim 1, wherein the blowing agent preparations comprise
a) from 2 to 99.99% by weight, based on the weight of the entire blowing agent preparation, of at least one organic and/or inorganic blowing agent,
b) from 0 to 10% by weight, based on the weight of the entire blowing agent preparation, of a surfactant compound and
c) optionally, up to 98% by weight, based on the weight of the entire blowing agent preparation, of other additives,
where the amounts of a), b) and c) total 100% by weight.

5. The blowing agent preparation of claim 4, wherein the amount of said at least one organic and/or inorganic blowing agent is from 70 to 99% by weight.

6. The blowing agent preparation of claim 4 wherein the amount of said surfactant is from 0.01 to 5% by weight.

7. Blowing agent preparations according to claim 1, wherein the blowing agent of comp. a) is selected from the group consisting of azodicarbonamide, hydrazodicarbonamide, oxybissulphohydrazide (OBSH), toluenesulphohydrazide (TSH), dinitropentamethylenetetramine (DPT), 5-phenyltetrazole (5-PT), benzenesulphohydrazide (BSH), paratoluenesulphonylsemicarbazide (PTSS), their alkali metal salts and their alkaline earth metal salts; and has an average primary particle size (median value of primary particle size distribution) of from 0.1 to 100 μm.

8. Blowing agent preparation of claim 7, wherein said average primary particle size is from 1 to 30 μm.

9. Blowing agent preparations according to claim 1, wherein the blowing agents of comp. a) are used alone or in mixtures with one another.

10. Blowing agent preparations according to claim 1, wherein the surfactant compound is a wetting agent and/or dispersing agent, having solubility in water at room temperature of more than 0.01 g/l, and having solubility in organic media of more than 20% by weight, based on the weight of the entire solution.

11. Blowing agent preparation according to claim 10, wherein said solubility in water is more than 0.1 g/l.

12. Blowing agent preparation according to claim 10, wherein said solubility in organic media is more than 40% by weight.

13. Blowing agent preparations according to claim 1, comprising a surfactant compound selected from the group consisting of the reaction products of ethylene oxide and/or propylene oxide with
saturated and/or unsaturated fatty alcohols having from 6 to 25 carbon atoms,
alkylphenols having from 4 to 12 carbon atoms in the alkyl radical,
saturated and/or unsaturated fatty amines having from 14 to 20 carbon atoms,
saturated and/or unsaturated fatty acids having from 14 to 22 carbon atoms,
hydrogenated and/or non-hydrogenated resin acids and/or
esterification and/or arylation products prepared from naturally occurring or optionally modified hydrogenated castor oil fats optionally linked via esterification with dicarboxylic acids to give repeating structural units.

14. Blowing agent preparations according to claim 1, comprising a surfactant compound selected from the group consisting of the
sorbitan esters and
reaction products of alkylene oxide with sorbitan ester.

15. Blowing agent preparations according to claim 1, comprising a surfactant selected from the group consisting of the
block (co)polymers based on ethylene oxide and/or propylene oxide,
block (co)polymers of ethylene oxide on bifunctional amines and/or of propylene oxide on bifunctional amines,
(poly)stearic-acid- and (poly)alkylene-oxide-based block copolymers, alkoxylated acetylenediols and -glycols,
polymers composed of repeat succinyl units
and combinations thereof.

16. Blowing agent preparations according to claim 1, comprising a surfactant compound selected from the group consisting of the alkoxylated phenols having the formula I) or II) 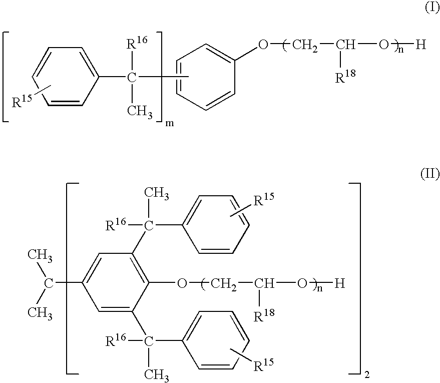
where
R¹⁵ is H or C₁-C₄-alkyl,
R¹⁶ is H or CH₃,
R¹⁷ is H, C₁-C₄-alkyl, C₁-C₄-alkoxy, C₁-C₄-alkoxycarbonyl or phenyl,
m is a number from 1 to 4,
n is a number from 2 to 50R¹⁸ is identical or different for each unit indicated by n and is H, CH₃ or phenyl, and where
R¹⁸ is identical or different for each unit indicated by n and represents hydrogen, CH₃ or phenyl, and, where CH₃ is present in the various —(—CH₂—CH(R18)O—)— groups, R¹⁸ represents CH₃ in from 0 to 60% of the total value of n and R¹⁸ represents hydrogen in from 100 to 40% of the total value of n, and, where phenyl is present in the various —(—CH₂—CH(R¹⁸)—O—)— groups, R¹⁸ represents phenyl in from 0 to 40% of the total value of n and R¹⁸ represents hydrogen in from 100 to 60% of the total value of n,
which are optionally ionically modified.

17. Blowing agent preparation of claim 16, wherein n is a number from 2 to 16.

18. Blowing agent preparations according to claim 1, comprising a surfactant compound of the formula III 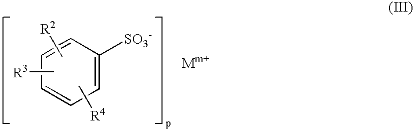
where
R², R³ and R⁴ are H or a C₁-C₂₄-alkyl radical,
where at least one of the substituents R², R³ and R⁴ is not hydrogen,
p is 1 or 2,
M is H, an ammonium radical or an alkali metal if m=1, and is an alkaline earth metal if m=2 and
R², R³ and R⁴ are H or a C₆-C₁₈-alkyl radical.

19. Blowing agent preparations according to claim 1, comprising a surfactant compound selected from the group consisting of the mono- and diesters of sulphosuccinic acid and their salts of the formula IV 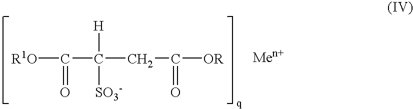
where
R and R¹ are H or a C₁-C₂₄ -hydrocarbon radical, but where R and R¹ are not simultaneously H,
q is 1 or 2 and
Me is H, an ammonium radical or an alkali metal if n=1, and an alkaline earth metal if n =2.

20. The blowing agent preparation of claim 19, wherein said hydrocarbon radical is a C₆-C₁₈-alkyl radical or an aralkyl radical.

21. Blowing agent preparations according to claim 1, comprising a surfactant selected from the group consisting of sodium bistridecyl sulphosuccinate, sodium dioctyl sulphosuccinate, sodium dihexyl sulphosuccinate, sodium diamyl sulphosuccinate, and mixtures thereof.

22. Blowing agent preparations according to claim 1, comprising azodicarbonamide and, optionally, a surfactant selected from the group consisting of sodium bistridecyl sulphosuccinate, sodium dioctyl sulphosuccinate, sodium dihexyl sulphosuccinate, sodium diamylsulphosuccinate and combination thereof.

23. Blowing agent preparations according to claim 1, comprising, as additive, water absorbents selected from the group consisting of silica gel, zeolites, aluminium oxide, magnesium oxide, magnesium hydroxide, calcium oxide, calcium hydroxide, organic anhydrides, magnesium sulphate, sodium carbonate and combinations thereof.

24. Blowing agent preparations according to claim 1, comprising azodicarbonamide and a surfactant compound selected from the group consisting of block (co)polymers based on ethylene oxide, block (co)polymers based on propylene oxide and combinations of such block (co)polymers.

25. Blowing agent preparations according to claim 10, comprising azodicarbonamide and, a surfactant compound composed of alkylbenzenesulphonates of the formula III.

26. Process for the preparation of blowing agent preparations wherein
1) at least one organic and/or one inorganic blowing agent is introduced into water, optionally together with a surfactant compound and/or, optionally, additives, and is homogenized to form a suspension,
2) the suspension from step 1) is comminuted in a wet process to an average primary particle size of from 0.1 to 100 μm for the blowing agent,
3) the suspension comminuted in a wet process from step 2) is dried, and
4) formed into granules,
where steps 3) and 4) may take place in reverse sequence or simultaneously, and the total content of organic and/or inorganic blowing agent, of the optional surfactant compound and of the optional additives is from 1 to 80% by weight, based on the weight of the suspension prior to the drying in step 3).

27. The process according to claim 26, wherein said average primary particle size is from 0.5 to 50 μm.

28. The process according to claim 27, wherein said average primary particle size is from 1 to 30 μm.

29. The process according to claim 26, wherein said total content of organic and/or inorganic blowing agent, optional surfactant and optional additives is from 30 to 60% by weight.

30. Process for the preparation of blowing agent preparations according to claim 26, wherein the comminution in the wet process in step 2) takes place either batchwise or continuously in a single-pass or circulating procedure by way of one or more milling assemblies with, optionally, different methods of milling.

31. Process for the preparation of blowing agent preparations according to claim 26, wherein the comminution in the wet process in step 2) takes place in high-speed stirrers, dissolvers, Ultra-Turrax, rotor-stator mills, in-line mixers, low-speed ball-mills with agitator unit, or centrifugal mills with energy density of 0.1 to 0.5 kW/l, based on the effective grinding space, or in high-speed ball- or bead-mills with agitator unit with energy density of from 0.5 to 3 kW/l and grinding beads composed of metal, glass or ceramic material, a dispersive kneader, roll mill, or high-pressure homogenizer.

32. Process for the preparation of blowing agent preparations according to claim 26, wherein after the comminution by a wet process in step 2) and prior to the drying in step 3) the product is neutralized and/or synthesis by-products and/or salts are removed, batchwise via isolation/filtration or continuously via crossflow microfiltration optionally in combination with diafiltration.

33. Process for the preparation of blowing agent preparations according to claim 26, wherein the drying (step 3) and, respectively, the granulation (step 4) are performed by spray drying, freeze drying, accumulative granulation, fluidized-bed drying and fluidized bed granulation, mixer agglomeration and mixer drying, mix-agglomeration in suspension, optionally with downstream fluidized-bed drying, granulation by means of paste-forming with downstream after-drying and comminution, or pelletization, or steam-jet agglomeration, or combinations of two or more of the foregoing.

34. Process for the preparation of azodicarbonamide which comprises
1) reacting an aqueous semicarbazide solution and/or hydrazine hydrate with urea, optionally after ammonia removal, to produce hydrazodicarbonamide and
2) oxidation of the hydrazodicarbonamide with an oxidant to produce azodicarbonamide,
wherein a surfactant compound is present prior to and/or during step 1) and/or prior to or during step 2).

35. Process for the preparation of azodicarbonamide according to claim 34, wherein said surfactant is present in an amount of from 0.001 to 2% by weight, based on the hydrazodicarbonamide formed in step 1) and/or azodicarbonamide in 2) and is:
A) a wetting agent and/or dispersing agent, having solubility in water at room temperature of more than 0.01 g/l, and having solubility in organic media of more than 20% by weight,
B) a reaction product of ethylene oxide and/or propylene oxide with
saturated and/or unsaturated fatty alcohols having from 6 to 25 carbon atoms,
alkylphenols having from 4 to 12 carbon atoms in the alkyl radical,
saturated and/or unsaturated fatty amines having from 14 to 20 carbon atoms,
saturated and/or unsaturated fatty acids having from 14 to 22 carbon atoms,
hydrogenated and/or non-hydrogenated resin acids and/or
esterification and/or arylation products prepared from naturally occurring or optionally modified hydrogenated castor oil fats optionally linked via esterification with dicarboxylic acids to give repeating structural units,
C) selected from the group consisting of the sorbitan esters and reaction products of alkylene oxide with sorbitan ester,
D) selected from the group consisting of the
block (co)polymers based on ethylene oxide and/or propylene oxide,
block (co)polymers of ethylene oxide on bifunctional amines and/or of propylene oxide on bifunctional amines,
(poly)stearic-acid- and (poly)alkylene-oxide-based block copolymers, alkoxylated acetylenediols and -glycols,
polymers composed of repeat succinyl units
and combinations thereof,
E) selected from the group consisting of the alkoxylated phenols having the formula I) or II) 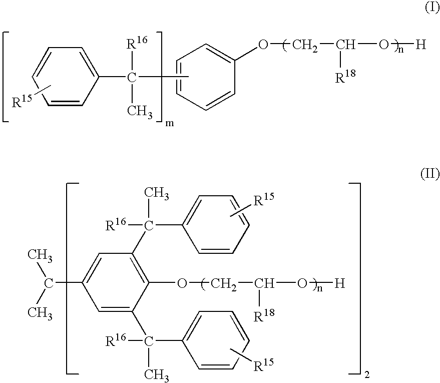
where
R¹⁵ is H or C₁-C₄-alkyl,
R¹⁶ is H or CH₃,
R¹⁷ is H, C₁-C₄-alkyl, C₁-C₄-alkoxy, C₁-C₄-alkoxycarbonyl or phenyl,
m is a number from 1 to 4,
n is a number from 2 to 50,
R¹⁸ is identical or different for each unit indicated by n and is H, CH₃ or phenyl, and where
a) R¹⁸ can only comprise H,
b) R¹⁸ can comprise a maximum of 60% of CH₃, the remainder then being H or not more than 40% of phenyl,
c) R¹⁸ can comprise a maximum of 40% of phenyl, the remainder being H or not more than 60% of CH₃,
which are optionally ionically modified.
F) a compound of the formula III 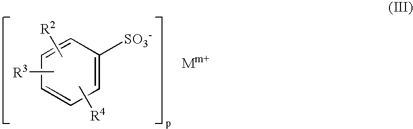
where
R², R³ and R⁴ are H or a C₁-C₂₄-alkyl radical,
where at least one of the substituents R², R³ and R⁴ is not hydrogen,
p is 1 or 2,
M is H, an ammonium radical or an alkali metal if m=1, and is an alkaline earth metal if m=2 and
R², R³ and R⁴ are H or a C₆-C₁₈-alkyl radical,
G) selected from the group consisting of the mono- and diesters of sulphosuccinic acid and their salts of the formula IV 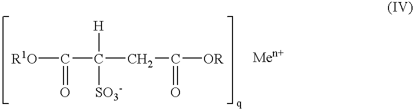
where
R and R¹ are H or a C₁-C₂₄-hydrocarbon radical, but where R and R¹ are not simultaneously H,
q is 1 or 2 and
Me is H, an ammonium radical or an alkali metal if n=1, and an alkaline earth metal if n=2, or
H) selected from the group consisting of sodium bistridecyl sulphosuccinate, sodium dioctyl sulphosuccinate, sodium dihexyl sulphosuccinate, sodium diamyl sulphosuccinate, and mixtures thereof.

36. Process according to claim 35, wherein said amount of said surfactant is 0.01 to 0.5% by weight.

37. Process for the preparation of azodicarbonamide according to claim 34, wherein said surfactant comprises alkylbenzenesulphonates of the formula III 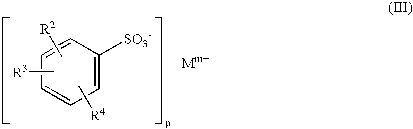
where
R², R³ and R⁴ are H or a C₁-C₂₄-alkyl radical,
where at least one of the substituents R², R³ and R⁴ is not hydrogen,
p is 1 or 2,
M is H, an ammonium radical or an alkali metal if m=1, and is an alkaline earth metal if m=2 and
R², R³ and R⁴ are H or a C₆-C₁₈-alkyl radical.

38. Process for the preparation of azodicarbonamide according to claim 34, wherein the surfactant compound comprises diesters of sulphosuccinic acid and their salts according to formula (IV) 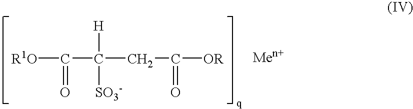
where
R and R¹ are H or a C₁-C₂₄-hydrocarbon radical where R and R¹ are not simultaneously H,
q is 1 or 2 and
Me is H, an ammonium radical or an alkali metal if n=1, and an alkaline earth metal if n=2.

39. Process of claim 38, wherein said hydrocarbon radical is a C₆-C₁₈-alkyl radical or an aralkyl radical.

40. A method for foaming thermoplastic polymers which comprises foaming them with the blowing agent of claim 1.
